(19) United States
(12) Patent Application Publication
(10) Pub. No.: US 2006/0283525 A1
(43) Pub. Date: Dec. 21, 2006

(54) Soft magnetic material and method for producing same

(76) Inventors: Haruhisa Toyoda, Itami-shi, Hyogo (JP); Ryoji Mizutani, Nishikamo-guh, Aichi (JP)

Correspondence Address: MCDERMOTT WILL & EMERY LLP, 600 13TH STREET, N.W., WASHINGTON, DC, 20005-3096, US

(21) Appl. No.: 10/570,608

(22) PCT Filed: Sep. 3, 2004
(86) PCT No.: PCT/JP04/12845

§ 371 Date: Mar. 3, 2006

(30) Foreign Application Priority Data
Sep. 3, 2003 (JP) 2003-311322

(51) Int. Cl. H01F 1/03

(52) U.S. Cl. 148/105

(57) ABSTRACT

A method for producing a soft magnetic material comprises a step wherein a plurality of composite magnetic particles, each of which is composed of a metal magnetic particle and an insulating coating film covering the surface of the metal magnetic particle, are formed into a compaction, and another step wherein the compaction is subjected to a heat treatment at not less than 400° C. and not more than 900° C. The insulating coating film contains at least one element selected from the group consisting of sulfur, selenium, titanium and aluminum. By having such a constitution, the resulting soft magnetic material can have desired magnetic characteristics.

### TECHNICAL FIELD

The present invention relates to a soft magnetic material and a method for producing the same, and more specifically, it relates to a soft magnetic material comprising composite magnetic particles having metal magnetic particles and insulating coating films and a method for producing the same.

### BACKGROUND ART

Electrical/electronic components have recently been densified and downsized, and capability of performing more precise control with small power is demanded in relation to motor cores and transformer cores. Therefore, development of a soft magnetic material, used for these electrical/electronic components, having excellent magnetic characteristics in intermediate and high frequency domains is in progress. In order to exhibit excellent magnetic characteristics in the intermediate and high frequency domains, the soft magnetic material must have high saturation magnetic flux density, high magnetic permeability and high electric resistivity.

As to such a soft magnetic material, Japanese Patent Laying-Open No. 55-130103, for example, discloses a method for producing a dust magnetic material (patent literature 1). In addition, Japanese Patent Laying-Open No. 9-180924 discloses a dust core and a method for producing the same (patent literature 2).

According to the method for producing a dust magnetic material disclosed in patent literature 1, metal magnetic powder, an inorganic insulating agent and an organic insulating binder are mixed with each other, and powder obtained by this mixing is thereafter pressure-formed. Thus, the dust magnetic material is so formed that the surfaces of particles of the metal magnetic powder are covered with inorganic insulating layers and further covered with organic insulating layers. The dust magnetic material obtained in this manner has high electric resistance.

According to the method for producing a dust core disclosed in patent literature 2, soft magnetic powder mainly composed of iron and SiO₂ oxide particulates are mixed with each other, and powder obtained by this mixing is thereafter powder-pressed. Thus, the dust core is so formed that particles of the soft magnetic powder are coated with insulating layers containing the SiO₂ oxide particulates and the particles of the soft magnetic powder are bonded to each other through the insulating layers. Then, the dust core is annealed at a temperature of at least 800° C. and not more than 1000° C., in order to release strains caused in the soft magnetic powder.

Patent Literature 1: Japanese Patent Laying-Open No. 55-130103

Patent Literature 2: Japanese Patent Laying-Open No. 9-180924

### DISCLOSURE OF THE INVENTION

Problems to be Solved by the Invention

According to the method for producing a dust magnetic material disclosed in patent literature 1, however, large numbers of strains and dislocations are caused in the metal magnetic powder in the pressure forming. Therefore, the magnetic characteristics of the dust magnetic material formed by the pressure forming are disadvantageously deteriorated due to these strains and dislocations.

In the method for producing a dust core disclosed in patent literature 2, the annealing for straightening is performed on the dust core at the temperature of at least 800° C. and not more than 1000° C. However, the temperature in the annealing is excessively high, to prompt diffusion of the SiO₂ oxide particulates toward the soft magnetic powder mainly composed of iron. The insulating layers containing the SiO₂ oxide particulates disappear or the quantity of impurities contained in the soft magnetic powder increases due to the diffusion of the SiO₂ oxide particulates. Thus, the magnetic characteristics of the dust core are disadvantageously deteriorated.

Accordingly, an object of the present invention is to solve the aforementioned problems, and to provide a soft magnetic material having desired magnetic characteristics and a method for producing the same.

Means for Solving the Problems

A method for producing a soft magnetic material according to an aspect of the present invention comprises the steps of preparing a compaction by pressure-forming a plurality of composite magnetic particles having metal magnetic particles and insulating coating films surrounding the surfaces of the metal magnetic particles and heat-treating the compaction at a temperature of at least 400° C. and not more than 900° C. The insulating coating films contain at least one element selected from a group consisting of sulfur (S), selenium (Se), titanium (Ti) and aluminum (Al).

According to the method for producing a soft magnetic material having this structure, sulfur, selenium, titanium or aluminum contained in the insulating coating films has a relatively small diffusion coefficient with respect to the metal magnetic particles. Therefore, this element can be inhibited from diffusing into the metal magnetic particles also when the compaction is heat-treated at a relatively high temperature. If the temperature for heat-treating the compaction is lower than 400° C. in this case, an effect by the heat treatment cannot be sufficiently attained. If the temperature for heat-treating the compaction is higher than 900° C., there is a possibility that the element contained in the insulating coating films diffuses into the metal magnetic particles to cause disappearance of the insulating coating films or increase the concentration of impurities in the metal magnetic particles. Therefore, the element contained in the insulating coating films can be inhibited from diffusion and the effect according to the heat treatment can be sufficiently attained by heat-treating the compaction in the temperature range according to the present invention. Thus, a soft magnetic material having desired magnetic characteristics can be formed.

Preferably, the insulating coating films further contain silicon (Si). Effects similar to the aforementioned effects can be attained also by the method for producing a soft magnetic material having this structure.

A method for producing a soft magnetic material according to another aspect of the present invention comprises the steps of preparing a compaction by pressure-forming a plurality of composite magnetic particles having metal magnetic particles and insulating coating films surrounding the surfaces of the metal magnetic particles and heat-treating the compaction at a temperature of at least 400° C. and less than 800° C. The insulating coating films contain silicon (Si).

According to the method for producing a soft magnetic material having this structure, silicon contained in the insulating coating films has a relatively small diffusion coefficient with respect to the metal magnetic particles. Therefore, silicon can be inhibited from diffusing into the metal magnetic particles also when the compaction is heat-treated at a relatively high temperature. If the temperature for heat-treating the compaction is lower than 400° C. in this case, an effect by the heat treatment cannot be sufficiently attained. If the temperature for heat-treating the compaction is at least 800° C., there is a possibility that silicon contained in the insulating coating films diffuses into the metal magnetic particles to cause disappearance of the insulating coating films or increase the concentration of impurities in the metal magnetic particles. Therefore, silicon contained in the insulating coating films can be inhibited from diffusion and the effect according to the heat treatment can be sufficiently attained by heat-treating the compaction in the temperature range according to the present invention. Thus, a soft magnetic material having desired magnetic characteristics can be formed.

Preferably, the step of heat-treating the compaction includes the step of heat-treating the compaction for at least 15 minutes and not more than 100 hours. If the time for performing the heat treatment is shorter than 15 minutes, the compaction is insufficiently heat-treated since this time is too short. If the time for performing the heat treatment exceeds 100 hours, the time required for the heat treatment is so excessively long that production efficiency for the soft magnetic material is reduced. Therefore, a soft magnetic material sufficiently attaining the effect of the heat treatment can be efficiently produced by setting the heat treatment time to at least 15 minutes and not more than 100 hours.

Preferably, the step of preparing the compaction includes the step of preparing the compaction having the plurality of composite magnetic particles bonded to each other through organic matter. According to the method for producing a soft magnetic material having this structure, the organic matter intervenes between the plurality of composite magnetic particles. Thus, the organic matter exhibits a function for serving as a lubricant. Therefore, breakage of the insulating coating films can be suppressed in the step of preparing the compaction. Thus, a soft magnetic material having desired magnetic characteristics can be formed.

In the step of preparing the compaction, well-known warm forming or die lubrication is so employed as to implement densification of the compaction and increase of the space factor thereof, leading to improvement of the magnetic characteristics. The powder temperature in the warm forming is preferably 100° C. to 180° C.

Preferably, the thickness of the insulating coating films is at least 0.005 μm and not more than 20 μm. According to the soft magnetic material having this structure, the insulating coating films can function as insulating films, and a soft magnetic material having desired magnetic characteristics can be implemented. In other words, insulation characteristics cannot be ensured with the insulating coating films if the thickness of the insulating coating films is smaller than 0.005 μm. If the thickness of the insulating coating films exceeds 20 μm, the volume ratio of the insulating coating films in the soft magnetic material so increases that desired magnetic characteristics cannot be obtained.

Preferably, the metal magnetic particles contain iron. The diffusion coefficient of the insulating coating films with respect to iron is at least 1×10¹⁸ (m²/sec) and not more than 1×10⁻¹⁴ (m²/sec). According to the soft magnetic material having this structure, the insulating coating films are so formed that the diffusion coefficient with respect to iron is relatively small. Thus, the insulating coating films can be further inhibited from diffusing into the metal magnetic particles in the step of heat-treating the compaction.

A soft magnetic material exhibiting magnetic flux density B of at least 1.6 (teslas) and electric resistivity ρ of at least 300 (μΩcm) upon application of a magnetic field of 8.0×10³ (A/m) can be formed by the method for producing a soft magnetic material according to any of the above,

Effect of the Invention

As hereinabove described, a soft magnetic material having desired magnetic characteristics and a method for producing the same can be provided according to the present invention.

### BRIEF DESCRIPTION OF THE DRAWINGS

FIG. 1 is a typical diagram showing a section of a powder compaction prepared by a method for producing a soft magnetic material according to a first embodiment of the present invention.

FIG. 2 is a graph showing the relation between diffusion coefficients of various elements with respect to iron and temperatures.

### DESCRIPTION OF THE REFERENCE SIGNS

10 metal magnetic particle, 20 insulating coating film, 30 composite magnetic particle, 40 organic matter.

### BEST MODES FOR CARRYING OUT THE INVENTION

A soft magnetic material is used as the material for a motor core or the like to which an AC magnetic field is applied. Therefore, magnetic characteristics capable of obtaining high magnetic flux density with small magnetic field strength and sensitively reacting against external magnetic variation are required to the soft magnetic material.

Energy loss referred to as iron loss is caused when the soft magnetic material is used in an AC magnetic field. This iron loss is roughly classified into hysteresis loss mainly caused in a low frequency domain and eddy-current loss mainly caused in a high frequency domain. The hysteresis loss denotes energy loss caused by energy necessary for changing the magnetic flux density of the soft magnetic material. The eddy current loss mentioned here denotes energy loss mainly caused by eddy current flowing between metal magnetic particles constituting the soft magnetic material. Magnetic characteristics reducing occurrence of this iron loss are required to the soft magnetic material.

In order to implement the aforementioned magnetic characteristics required to the soft magnetic material, it is necessary to increase magnetic permeability μ, saturation magnetic flux density B and electric resistivity ρ of the soft magnetic material and reduce coercive force Hc of the soft magnetic material. The inventors have completed a soft magnetic material having these magnetic characteristics and a method for producing the same.

Embodiments of the present invention are now described with reference to the drawings.

### First Embodiment

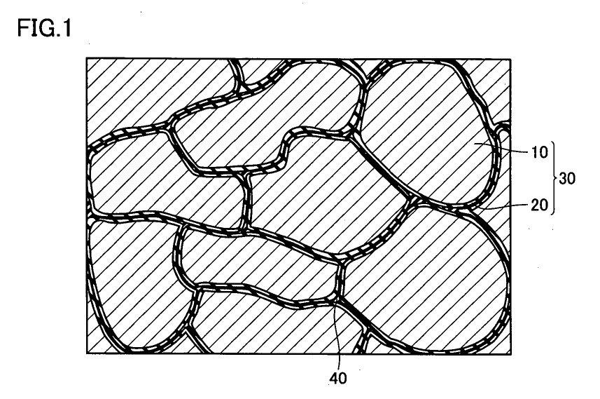

Referring to FIG. 1, a powder compaction prepared by a method for producing a soft magnetic material according to a first embodiment of the present invention comprises a plurality of composite magnetic particles 30 having metal magnetic particles 10 and insulating coating films 20 surrounding the surfaces of the metal magnetic particles 10. The plurality of composite magnetic particles 30 are bonded to each other through organic matter 40, or bonded to each other through engagement between cavities and projections of the particles.

This powder compaction exhibits magnetic flux density B100 of at least 1.6 (teslas) and electric resistivity p of at least 300 (μΩcm) upon application of a magnetic field of 100 (oersteds) (=8.0×10³ (A/m)).

A method for producing the soft magnetic material according to this embodiment is now described. First, composite magnetic particles are formed by coating the surfaces of metal magnetic particles with insulating coating films.

The metal magnetic particles are made of iron (Fe). The metal magnetic particles are not restricted to iron, but may alternatively be made of an iron (Fe)-silicon (Si) alloy, an iron (Fe)-nitrogen (N) alloy, an iron (Fe)-nickel (Ni) alloy, an iron (Fe)-carbon (C) alloy, an iron (Fe)-boron (B) alloy, an iron (Fe)-cobalt (Co) alloy, an iron (Fe)-phosphorus (P) alloy, an iron (Fe)-nickel (Ni)-cobalt (Co) alloy or an iron (Fe)-aluminum (Al)-silicon (Si) alloy. The metal magnetic particles may be of a simple substance of metal or an alloy.

The average particle diameter of the metal magnetic particles is preferably at least 5 μm and not more than 200 μm. If the average particle diameter of the metal magnetic particles is less than 5 μm, the metal is so easily oxidized that the magnetic characteristics of the soft magnetic material may be reduced. If the average particle diameter of the metal magnetic particles exceeds 200 μm, compressibility of mixed powder is reduced in a subsequent pressure-forming step. Thus, the density of a compaction obtained through the pressure-forming step may be so reduced that it is difficult to handle the compaction.

It is to be noted that the average particle size described herein refers to a particle size obtained when the sum of masses of particles added in ascending order of particle size in a histogram of particle sizes measured by sieving reaches 50% of the total mass, that is, 50% particle size D.

An oxide insulator containing at least one of sulfur, selenium, titanium and aluminum is employed for the insulating coating films. The insulating coating films may contain silicon. The electric resistivity ρ of the soft magnetic material can be increased by providing the insulating coating films as insulating layers covering the surfaces of the metal magnetic particles. Thus, iron loss of the soft magnetic material resulting from eddy current can be reduced by inhibiting the eddy current from flowing between the metal magnetic particles.

The thickness of the insulating coating films covering the surfaces of the metal magnetic particles is set to at least 0.005 μm and not more than 20 μm. Energy loss resulting from eddy current can be effectively suppressed by setting the thickness of the insulating coating films to at least 0.005 μm. When the thickness of the insulating coating films is set to not more than 20 μm, the volume ratio of the insulating coating films in the soft magnetic material is not excessively increased. Thus, a soft material having prescribed saturation magnetic flux density B can be formed.

Then, mixed powder is obtained by mixing the composite magnetic particles and organic matter with each other. The mixing method is not restricted but any of mechanical alloying, vibration ball milling, satellite ball milling, mechanofusion, coprecipitation, chemical vapor deposition (CVD), physical vapor deposition (PVD), plating, sputtering, vapor deposition and a sol-gel process can be used.

Thermoplastic resin such as thermoplastic polyimide, thermoplastic polyamide, thermoplastic polyamidimide, polyphenylene sulfide, polyamidimide, poly(ethersulfone), polyether imide or poly(etheretherketone) can be employed for the organic matter. This organic matter is so provided that the organic matter functions as a lubricant between the plurality of composite magnetic particles. Thus, breakage of the insulating coating films can be suppressed in the pressure-forming step.

Alternatively, non-thermoplastic resin such as total aromatic polyester or total aromatic polyimide may be employed for the organic matter. The non-thermoplastic resin denotes resin having characteristics similar to those of thermoplastic resin but exhibiting a melting point not present at a temperature of not more than the thermal decomposition temperature.

Then, only the composite magnetic particles or the mixed powder of the composite magnetic particles and the organic matter is introduced into a metal mold. The powder is pressure-formed with a pressure of 390 (MPa) to 1500 (MPa), for example. Thus, a compaction of compressed powder is obtained. The mixed powder is preferably pressure-formed in an inert gas atmosphere or a decompressed atmosphere. In this case, the mixed powder can be prevented from oxidation by oxygen in the atmosphere.

Then, the compaction obtained by the pressure forming is heat-treated at a temperature of at least 400° C. and not more than 900° C. Large numbers of strains and dislocations are caused in the compaction obtained through the pressure-forming step. These strains and dislocations can be eliminated. If the organic matter is added to the compaction, the compaction is heat-treated in order to soften the organic matter contained in the compaction and introduce the organic matter into the clearances between the plurality of composite magnetic particles.

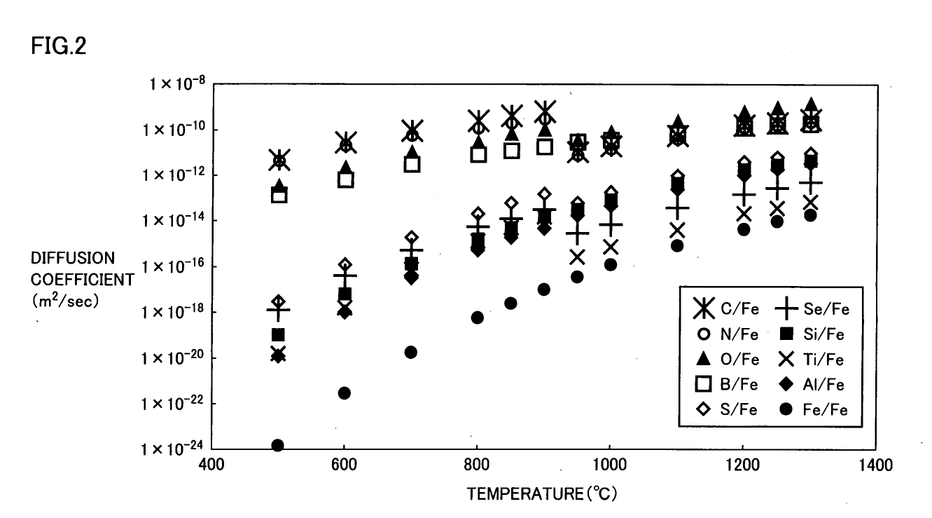

Referring to FIG. 2, the axis of ordinates shows diffusion coefficients (m²/sec) and the axis of abscissas shows temperatures in this graph. The diffusion coefficients of various elements increase as the temperature increases. The increase of the diffusion coefficients may be discontinuous around the temperature of 900° C., since iron phase-changes from α-Fe to γ-Fe at 912° C.

The elements shown in FIG. 2 can be classified into a group having diffusion coefficients plotted in the range of relatively small values and a group having diffusion coefficients plotted in the range of relatively large values. Sulfur (S), selenium (Se), silicon (Si), titanium (Ti) and aluminum (Al) can be listed as the elements belonging to the former group, and carbon (C), nitrogen (N) and boron (B) can be listed as the elements belonging to the latter group.

In other words, the oxide insulator forming the insulating coating films includes an element having a relatively small diffusion coefficient. Therefore, the element can be inhibited from diffusing into iron forming the metal magnetic particles also when the compaction is heat-treated at the high temperature of at least 400° C. and not more than 900° C.

The diffusion coefficient of the insulating coating films with respect to iron is preferably at least 1×10⁻¹⁸ (m²/sec) and not more than 1×10⁻¹⁴ (m²/sec). The insulating coating films can be further inhibited from diffusing into the metal magnetic particles by forming the insulating coating films so that the diffusion coefficient is in this range.

The time for heat-treating the compaction is preferably set to at least 15 minutes and not more than 100 hours. In this case, it is possible to eliminate strains and dislocations from the compaction and improve the production efficiency for the soft magnetic material through the heat treatment.

The atmosphere for the heat treatment is preferably an inert gas atmosphere or a decompressed atmosphere. In this case, the mixed powder can be prevented from oxidation by oxygen in the atmosphere.

The powder compaction shown in FIG. 1 is completed through the aforementioned steps.

The method for producing a soft magnetic material according to the first embodiment of the present invention comprises steps of preparing a compaction by pressure-forming a plurality of composite magnetic particles having metal magnetic particles and insulating coating films surrounding the surfaces of the metal magnetic particles and heat-treating the compaction at the temperature of at least 400° C. and not more than 900° C. The insulating coating films contain at least one element selected from a group of sulfur, selenium, titanium and aluminum.

The step of preparing the compaction includes a step of preparing the compaction so that the plurality of composite magnetic particles are bonded to each other through engagement between cavities and projections thereof, and the plurality of composite magnetic particles are bonded to each other through organic matter when containing the organic matter.

According to the soft magnetic material having this structure and the method for producing the same, the insulating coating films contain sulfur, selenium, titanium or aluminum having a relatively small diffusion coefficient with respect to the metal magnetic particles. Therefore, the insulating coating films can be inhibited from diffusing into the metal magnetic particles in the heat treatment step. Thus, a situation such as disappearance of the insulating coating films can be so avoided that iron loss of the soft material can be reduced by suppressing generation of eddy current. Further, such a situation that impurity concentration of the metal magnetic particles increases due to diffusion of the insulating coating films can also be avoided. Thus, the magnetic permeability μ of the soft magnetic material can be prevented from reduction.

On the other hand, strains and dislocations can be eliminated from the compaction by heat-treating the compaction at the prescribed temperature. Thus, iron loss of the soft magnetic material can be reduced by reducing coercive force Hc and increasing the magnetic permeability μ. In addition, breaking strength of the soft magnetic material can also be improved due to the effect of the high-temperature heat treatment.

### Second Embodiment

A method for producing a soft magnetic material according to a second embodiment comprises steps substantially similar to those of the method for producing a soft magnetic material according to the first embodiment. However, an oxide insulator employed for insulating coating films and temperature setting in a heat treatment step are different from those in the first embodiment. Redundant description of the method is not repeated.

First, composite magnetic particles are prepared by covering the surfaces of metal magnetic particles with insulating coating films. An oxide insulator containing silicon is employed for the insulating coating films. Also in this case, electric resistivity p of the soft magnetic material can be increased by providing the insulating coating films. Thus, iron loss of the soft magnetic material can be reduced by suppressing generation of eddy current.

After carrying out a pressure-forming step, a compaction obtained by pressure forming is heat-treated at a temperature of at least 400° C. and less than 800° C. Referring to FIG. 2, the oxide insulator forming the insulating coating films includes silicon having a relatively small diffusion coefficient. Therefore, silicon can be inhibited from diffusing into iron forming the metal magnetic particles also when the compaction is heat-treated at the high temperature of at least 400° C. and less than 800° C.

The method for producing a soft magnetic material according to the second embodiment of the present invention comprises steps of preparing a compaction by pressure-forming a plurality of composite magnetic particles having metal magnetic particles and insulating coating films surrounding the surfaces of the metal magnetic particles and heat-treating the compaction at a temperature of at least 400° C. and less than 800° C. The insulating coating films contain silicon.

According to the method for producing a soft magnetic material having this structure, effects similar to those described in relation to the first embodiment can be attained.

The soft magnetic material obtained by the method according to the first or second embodiment can be applied to a choke coil, electronic components such as a switching power supply element and a magnetic head, various motor components, an automobile solenoid, various magnetic sensors and magnetic electromagnetic valves.

While the step of mixing the composite magnetic particles and the organic matter with each other is carried out in the method for producing a soft magnetic material according to the first or second embodiment, this step is not requisite in the present invention. In other words, the compaction may alternatively prepared by forming composite magnetic particles and thereafter pressure-forming the composite magnetic particles.

### EXAMPLE

The soft magnetic material according to the present invention was evaluated by Example described below.

Iron particles having an average particle diameter of 70 μm were prepared as metal magnetic particles. These iron particles were coated with SiO₂ films serving as insulating coating films by a wet method. At this time, the iron particles were coated while aiming at a thickness of about 100 nm for the SiO₂ films. Composite magnetic particles were formed by surrounding the surfaces of the iron particles with the SiO₂ films through this coating.

Mixed powder was prepared by mixing the composite magnetic particles and particles of polyphenylene sulfide resin having an average particle diameter of not more than 100 μm with each other. The mixed powder was introduced into a metal mold and subjected to pressure forming. At this time, the pressure forming was performed in a nitrogen gas atmosphere, and the pressure was set to 882 (MPa). Thus, a compaction of a sample 1 was obtained.

The compaction of the sample 1 was heat-treated. The heat treatment was performed in a nitrogen gas atmosphere for 1 hour. The temperature for heat-treating the compaction was varied from 400° C. up to 1200° C. every 100° C., thereby forming a soft magnetic material heat-treated at each temperature.

Electric resistivity ρ, magnetic permeability μ and coercive force Hc of the soft magnetic material obtained at each heat treatment temperature were measured. The electric resistivity ρ was measured by a four-point probe method. Magnetic flux density B100 upon application of a magnetic field of 100 (oersteds) (=8.0×10³ (A/m)) at the ordinary temperature was obtained. The magnetic flux density B100 was obtained by setting the primary and secondary winding numbers of a coil applying the magnetic field to 300 turns and 20 turns respectively and measuring the output of a secondary coil.

A compaction of a sample 2 was formed through steps identical to the above, and similarly subjected to heat treatment under various temperature conditions. The electric resistivity ρ of a soft magnetic material obtained from the compaction of the sample 2 was measured. Further, a compaction of a sample 3 was formed through steps identical to the above by employing Al₂O₃ films as insulating coating films in place of SiO₂ films. Also as to the compaction of the sample 3, heat treatment was performed under various temperature conditions for measuring electric resistivity ρ etc. of a soft magnetic material obtained through the heat treatment.

Table 1 shows values of the electric resistivity ρ(μΩcm), the magnetic flux density B100 (T), the magnetic permeability μ and the coercive force Hc (Oe) (oersteds) of the soft magnetic materials obtained from the compaction of the samples 1 to 3 every heat treatment temperature condition.

TABLE 1

| | Sample 1 (SiO₂ Film) | | | | Sample 2 (SiO₂ Film) | | | | Sample 3 (Al₂O₃ Film) | | | |
|---|---|---|---|---|---|---|---|---|---|---|---|---|
| | Electric | Electric | | | Electric | Magnetic | | | Electric | Magnetic | | |
| Heat | Resis- | Resis- | Magnetic | Coercive | Resis- | Flux | Magnetic | Coercive | Resis- | Flux | Magnetic | Coercive |
| Treatment | tivity | tivity | Perme- | Force | tivity | Density | Perme- | Force | tivity | Density | Perme- | Force |
| Tempera- | ρ | B100 | ability | Hc | ρ | B100 | ability | Hc | ρ | B100 | ability | Hc |
| ture | (μΩcm) | (T) | μ | (Oe) | (μΩcm) | (T) | μ | (Oe) | (μΩcm) | (T) | μ | (Oe) |
| 400 | 320 | 1.69 | 975 | 3.87 | 1013 | 1.68 | 969 | 3.90 | 1850 | 1.61 | 983 | 4.27 |
| 500 | 322 | 1.70 | 1396 | 3.51 | 1011 | 1.70 | 1382 | 3.52 | 1852 | 1.64 | 1195 | 4.09 |
| 600 | 321 | 1.71 | 1872 | 3.27 | 1008 | 1.71 | 1805 | 3.31 | 1851 | 1.65 | 1521 | 3.93 |
| 700 | 323 | 1.71 | 2437 | 2.93 | 1013 | 1.71 | 2387 | 3.02 | 1855 | 1.65 | 1916 | 3.61 |
| 800 | 308 | 1.71 | 3126 | 2.58 | 998 | 1.71 | 3097 | 2.65 | 1831 | 1.65 | 2350 | 3.35 |
| 900 | 307 | 1.71 | 3133 | 2.57 | 993 | 1.70 | 3089 | 2.63 | 1827 | 1.65 | 2352 | 3.35 |
| 1200 | 49 | 1.43 | 2828 | 2.46 | 54 | 1.31 | 2793 | 2.47 | 103 | 1.23 | 1827 | 2.6 |

Referring to the results of the samples 1 and 2 in Table 1, it was possible to hold the electric resistivity ρ at large values when the heat treatment temperature was at least 400° C. and less than 800° C., as compared with the case where the heat treatment temperature was at least 800° C. Thus, it was possible to confirm that the SiO₂ films served as insulating films without disappearance also after the heat treatment. On the other hand, it was possible to set the magnetic flux density B100 and the magnetic permeability μ to large values while setting the coercive force Hc to small values in the aforementioned temperature range. Thus, it was possible to confirm that effects were sufficiently attained through the heat treatment. The samples 1 and 2 were different in electric resistivity ρ from each other conceivably because iron particles were coated with the SiO₂ films having different thicknesses.

Referring to the results of the sample 3 in Table 1, it was possible to hold the electric resistivity ρ at large values when the heat treatment temperature was at least 400° C. and not more than 900° C., as compared with the case where the heat treatment temperature exceeded 900° C. Thus, it was possible to confirm that the Al₂O₃ films served as insulating films without disappearance also after the heat treatment. On the other hand, it was possible to set the magnetic flux density B100 and the magnetic permeability μ to large values while setting the coercive force Hc to small values in the aforementioned temperature range. Thus, it was possible to confirm that effects were sufficiently attained through the heat treatment.

It was possible to confirm that the soft magnetic material according to the present invention can satisfy the magnetic characteristics required to the soft magnetic material.

The embodiments and Example disclosed this time must be considered as illustrative in all points and not restrictive. The scope of the present invention is shown not by the above description but by the scope of claim for patent, and it is intended that all modifications within the meaning and range equivalent to the scope of claim for patent are included.

### INDUSTRIAL APPLICABILITY

The present invention is mainly utilized for manufacturing an electrical/electronic component such as a motor core or a transformer core prepared from a powder compaction of a soft magnetic material.

1. A method for producing a soft magnetic material, comprising the steps of:
preparing a compaction by pressure-forming a plurality of composite magnetic particles (30) having metal magnetic particles (10) and insulating coating films (20), containing at least one element selected from a group consisting of sulfur, selenium, titanium and aluminum, surrounding the surfaces of said metal magnetic particles (10); and
heat-treating said compaction at a temperature of at least 400° C. and not more than 900° C., wherein
said step of preparing said compaction includes the step of preparing said compaction having said plurality of composite magnetic particles (30) bonded to each other through organic matter (40), and
the thickness of said insulating coating films (20) is at least 0.005 μm and not more than 20 μm.

2. The method for producing a soft magnetic material according to claim 1, wherein said insulating coating films (20) further contain silicon.

3. The method for producing a soft magnetic material according to claim 1, wherein said step of heat-treating said compaction includes the step of heat-treating said compaction for at least 15 minutes and not more than 100 hours.

4. (canceled)

5. (canceled)

6. The method for producing a soft magnetic material according to claim 1, wherein said metal magnetic particles (10) contain iron, and the diffusion coefficient of said insulating coating films (20) with respect to iron is at least 1×10⁻¹⁸ (m²/sec) and not more than 1×10⁻¹⁴ (m²/sec).

7. A soft magnetic material formed by the method for producing a soft magnetic material according to claim 1, wherein
magnetic flux density B is at least 1.6 (teslas) and electric resistivity ρ is at least 300 (μΩcm) upon application of a magnetic field of 8.0×10³ (A/m).

8. A method for producing a soft magnetic material, comprising the steps of:
preparing a compaction by pressure-forming a plurality of composite magnetic particles (30) having metal magnetic particles (10) and insulating coating films (20), containing silicon, surrounding the surfaces of said metal magnetic particles (10); and
heat-treating said compaction at a temperature of at least 400° C. and less than 800° C., wherein
said step of preparing said compaction includes the step of preparing said compaction having said plurality of composite magnetic particles (30) bonded to each other through organic matter (40), and
the thickness of said insulating coating films (20) is at least 0.005 μm and not more than 20 μm.

9. The method for producing a soft magnetic material according to claim 8, wherein said step of heat-treating said compaction includes the step of heat-treating said compaction for at least 15 minutes and not more than 100 hours.

10. (canceled)

11. (canceled)

12. The method for producing a soft magnetic material according to claim 8, wherein said metal magnetic particles (10) contain iron, and the diffusion coefficient of said insulating coating films (20) with respect to iron is at least 1×10⁻¹⁸ (m²/sec) and not more than 1×10⁻¹⁴ (m²/sec).

13. A soft magnetic material formed by the method for producing a soft magnetic material according to claim 8, wherein
magnetic flux density B is at least 1.6 (teslas) and electric resistivity ρ is at least 300 (μΩcm) upon application of a magnetic field of 8.0×10³ (A/m).
